(19) United States
(12) Patent Application Publication
(10) Pub. No.: US 2007/0166486 A1
(43) Pub. Date: Jul. 19, 2007

(54) Ink jet recording media

(75) Inventors: Tomoya Kubota, Shizuoka-ken (JP); Kentaro Shiratsuchi, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/650,497

(22) Filed: Jan. 8, 2007

(30) Foreign Application Priority Data
Jan. 13, 2006 (JP) 2006-006217

(51) Int. Cl. B41M 5/50

(52) U.S. Cl. 428/32.34

(57) ABSTRACT

In an ink-jet recording media, an ink receiving layer formed over a transparent support having a total-light-ray transmittance of 80% or more contains inorganic particles A having an average of agglomerated particle diameters of from 0.5 μm to less than 1 μm and inorganic particles B having an average of agglomerated particle diameters of from 7.5 μm to less than 10 μm at a ratio A/B of 25/75 to 75/25.

### CROSS-REFERENCE TO RELATED APPLICATION

This application claims priority under 35 USC 119 from Japanese patent Application Nos. 2006-6217, the disclosures of which are incorporated by reference herein.

### BACKGROUND OF THE INVENTION

(i) Field of the Invention

The invention relates to an ink jet recording media, and in particular to an ink jet recording media wherein light is radiated onto the reverse face of an image observing face (i.e., the side of the back) to display a transmission image.

(ii) Description of the Related Art

Printed boards prepared as full color prints by means of ink-jet printers are used as display advertisements in department stores, platforms in stations of subways, railways or the like, restaurants, lobbies in hotels, and other various places.

In particular, a backlight film is known, wherein light is radiated to the back face of a printed board and the radiated light is transmitted through the printed board, thereby visualizing pictures, characters or the like that are recorded in a supporting film or the like so as to give a display image.

For backlight films, a printer in a wide format is mainly used as an ink-jet printer for printing images onto the films. However, dependently on the model of the printer, the amount of jetted ink is varied. Thus, the density of developed color is also varied. In the case that an all-purpose ink jet recording media is used at the time of printing an image by use of such a printer in a wide format, the ink-jet absorbing capacity of the media is insufficient. Thus, it is feared that image poorness is generated by an overflow of ink.

As a technique related to the density of developed color in ink-jet recording, suggested is an ink jet recording media wherein titanium oxide (white pigment) is formed as an underlying layer by calendaring and then a coating solution containing wet-method silica is applied onto this underlying layer (see, for example, Japanese Patent Application Laid-Open (JP-A) No. 2000-211120).

As the ink jet recording media having a porous ink absorbing layer on the transparent support, suggested is also an ink-jet recoding media wherein an ink absorbing layer is made of at least a polymer having a quaternary ammonium salt group and pigment particles having a refractive index of 1.7 or less (see, for example, JP-A No. 8-282092).

### SUMMARY OF THE INVENTION

However, according to the above-mentioned ink-jet recording media or member to be subjected to ink-jet recording, an overflow of ink is generated so that light is insufficiently scattered in locations where dye is present. Accordingly, there is the problem that the density of images decreases and a high transmission density cannot be obtained. Furthermore, there is a problem may occur whereby even if an image has a considerably high black density, transmitted light may yellow due to particles in the medium or member.

The invention has been made in light of the above-mentioned situation, and an object thereof is to provide an ink-jet recording media with which an overflow of ink is suppressed at the time of recording, and the color hue of black is favorable so that images having a high black density can be recorded.

The invention has been made on the basis of the following finding: when inorganic particles having particle diameters different from each other are used together at a predetermined ratio, an overflow of jetted ink (ink overflow) is eliminated at the time of recording, and the use of such particles is particularly effective for improving the transmission density and the black color hue of a black image which is visually displayed by light radiated onto the reverse face to an image observing face of the media or member.

A first aspect of the invention provides an ink-jet recording media comprising: a transparent support having a total-light-ray transmittance of 80% or more; and an ink receiving layer which is arranged over the transparent support and comprises inorganic particles A wherein the average of agglomerated particle diameters is from 0.5 μm to less than 1 μm, and inorganic particles B wherein the average of agglomerated particle diameters is from 7.5 μm to less than 10 μm, the blend ratio of the inorganic particles A to the inorganic particles B (A/B) being from 25/75 to 75/25.

A second aspect of the invention provides a method of producing an ink-jet recording media, comprising applying, over a transparent support having a total-light-ray transmittance of 80% or more, a coating solution comprising inorganic particles A wherein the average of agglomerated particle diameters is from 0.5 μm to less than 1 μm and inorganic particles B wherein the average of agglomerated particle diameters is from 7.5 μm to less than 10 μm, the blend ratio of the inorganic particles A to the inorganic particles B (A/B) being from 25/75 to 75/25, thereby forming an applied layer; and giving the applied layer a basic solution having a pH of 7.1 or more (1) at the same time when the coating solution is applied, thereby forming the applied layer, or (2) in the middle of drying the applied layer formed by the applying of the coating solution and before the applied layer exhibits falling rate drying, thereby crosslinking and curing the applied layer.

### DETAILED DESCRIPTION OF THE INVENTION

Hereinbelow, the ink jet recording media of the invention will be described in detail.

The ink jet recording media of the invention has at least one ink receiving layer over a transparent support having a total-light-ray transmittance of 80% or more. If necessary, the ink jet recording media of the invention may have one or more different layers.

### —Transparent Support—

The ink jet recording media of the invention is constituted by using a transparent support having a total-light-ray transmittance of 80% or more as its support. Therefore, when light is radiated onto the backside of the ink jet recording media, which is the reverse face to an image observing face thereof, so as to display an image, a difference in density between the image area and the non-image area is large so that the image can be a bright image.

The “transparent” means a total-light-ray transmittance of 80% or more. The total-light-ray transmittance (%) in the invention is measured by use of HGM-2DP manufactured by Suga Test Instruments Co., Ltd.

It is desired that the total-light-ray transmittance is higher to obtain bright image. The total-light-ray transmittance is preferably 85% or more.

The transparent support can be preferably made of a transparent material having resistance against radiant heat when the support is used in a backlight display.

Examples of the material include polyesters such as a polyethylene terephthalate (PET); and other polymers such as polysulfone, polyphenylene oxide, polyimide, polycarbonate, and polyamide. Among them, polyesters are preferred, and polyethylene terephthalate is in particular preferred.

It is preferable that the surface of the transparent support on which an ink receiving layer is to be formed is subjected to undercoating treatment in order to improve the adhesiveness of the ink receiving layer onto the support. The undercoating treatment can be conducted, for example, by applying a solution or dispersion in which gelatin or a resin component such as SBR is dissolved or dispersed, or by a surface treatment such as corona treatment.

The thickness of the transparent support is not particularly limited, and is preferably from 50 to 200 μm from the viewpoint of the handling characteristics of the support.

### —Ink Receiving Layer—

The ink receiving layer in the invention comprises inorganic particles A wherein the average of agglomerated particle diameters is from 0.5 μm to less than 1 μm, and inorganic particles B wherein the average of agglomerated particle diameters is from 7.5 μm to less than 10 μm. If necessary, the ink receiving layer may be constituted by containing one or more other components such as a water-soluble resin or a cross-linking agent.

### <Inorganic Particles>

In the invention, the ink receiving layer comprises, as fine particles, inorganic particles A wherein the average of agglomerated particle diameters, which may be abbreviated merely to the “particle diameter” hereinafter, is from 0.5 μm to less than 1 μm, and inorganic particles B wherein the average of agglomerated particle diameters is from 7.5 μm to less than 10 μm. The ink receiving layer in the invention is made by use of at least two of inorganic particles wherein the averages of agglomerated particle diameters are different from each other, thereby improving the total-light-ray transmittance and further improving the transmittance density of an image on the medium effectively. This makes it possible that the ink jet recording media of the invention gives a high density in its image area and further a bright image, wherein a difference in density between the image area and the non-image area is large, is displayed. In accordance with the used inorganic particles, transmitted light, which is radiated from the backside (by a white fluorescent lamp or the like) and transmitted through the medium, may yellow. However, according to the ink jet recording media of the invention, the medium can be suppressed from yellowing by specifying the average agglomerated particle diameters into the above-mentioned ranges.

If the particle diameters are too small apart from the invention (for example, if only the inorganic particles A, which have relatively small particle diameters, are used without using the inorganic particles B, which have relatively large particle diameters), the total-light-ray transmittance lowers so that a dark image is obtained. Conversely, if the particle diameters are too large (for example, if only the inorganic particles B, which have relatively large particle diameters, are used without using the inorganic particles A, which have relatively small particle diameters), the transmission density cannot be improved up to a high density of 5.0 or more although the total-light-ray transmittance can be kept to some degree.

The average of agglomerated particle diameters in the invention means a value of the median diameter obtained when inorganic particles are dispersed in water and then the particle diameters of the resultant particles are measured with a specific measuring device (trade name: LA-920, manufactured by Horiba Ltd.).

The transmission density can be measured with a specific measuring device (trade name: X-rite 310, manufactured by X-rite Co.).

The ink receiving layer is more preferably an ink receiving layer wherein the inorganic particles A wherein the average of agglomerated particle diameters is from 0.5 μm to less than 0.8 μm and the inorganic particles B wherein the average of agglomerated particle diameters is from 7.5 μm to less than 9 μm are combined since a higher total-light-ray transmittance and a higher transmission density can be obtained.

The inorganic particles A and B, which constitute the ink receiving layer according to the invention, may be of the same species or different species. These can be appropriately selected from, for example, silica particles (examples of which include vapor-phase-process silica and sedimentation process silica), colloidal silica, and particles made of titanium dioxide, barium sulfate, calcium silicate, zeolite, kaolinite, halloysite, mica, talc, calcium carbonate, magnesium carbonate, calcium sulfate, boehmite, or pseudo-boehmite.

In the invention, the average of the agglomerated particle diameters of the inorganic particles is in the particle diameter range of less than 10 nm. Accordingly, when a dispersion solution for forming the ink receiving layer is prepared, the dispersion solution can be prepared as a dispersion solution wherein the particles are more finely dispersed. Since the average of the agglomerated particle diameters is in particular a small diameter of less than 10 nm, the ink receiving layer in the invention is good in ink absorbing property so that the surface gloss thereof is also improved. Additionally, since the average of the agglomerated particle diameters is less than 10 nm, the density of the image to be recorded can be kept at a high level, thus the invention is effective for an improvement in the ozone resistance and the light-fastness of the image.

Among them, silica particles are in particular preferable. Examples of the silica particles include vapor-phase-process silica, and sedimentation process silica which will also be referred to as hydrated silica. The inorganic particles are more preferably sedimentation process silica.

When other inorganic particles are used together with sedimentation process silica, the percentage of sedimentation process silica in the total of the inorganic particles is preferably 50% or more by mass, more preferably 60% or more by mass.

Silica particles, a typical example of which is sedimentation process silica, have a particularly large specific surface. Thus, the particles can make the ink receiving layer into a porous structure. Accordingly, the particles are effective for improving the absorbing efficiency of ink and the retention efficiency thereof. Additionally, the particles have a low refractive index; therefore, when the particles having the above-mentioned particle diameters are contained in the layer, the particles can give transparency to the layer so that a high color density and a good color hue can be certainly kept. Furthermore, the silica particles have in the surfaces thereof silanol groups; thus, the particles adhere easily to each other by hydrogen bonding based on the silanol groups. Moreover, the silica particles adhere easily to each other through the silanol group and a water-soluble resin; therefore, the silica particles can give a high transparency in the above-mentioned particle diameter ranges. As a result, the silica particles can improve the ink absorbing property, therefore the image density.

Silica particles are commonly classified roughly into wet method particles and dry method (vapor phase process) particles according to the method of manufacture. In the vapor phase process, the silica (anhydrous silica) particles are mainly produced by high-temperature gas-phase hydrolysis of a silicon halide (flame hydrolysis method), or by reductively heating and vaporizing silica sand and coke in an electric furnace by applying an arc discharge and then oxidizing the vaporized silica with air (arc method). The “vapor-phase-process silica” means an anhydrous silica particle. Alternatively by the wet method, silica particles are mainly produced by generating an activated silica by acid decomposition of a silicate, polymerizing properly the activated silica, and aggregating the polymerized silica to give a hydrated silica.

The pseudo-boehmite, which has been referred to above, is represented by Al₂O₃.xH₂O (1<x<2). The crystal thereof is generally a lamellar compound wherein the (020) faces thereof each form a giant plane. The lattice constant d thereof is 0.67 nm. The pseudo-boehmite has a structure wherein an excessive amount of water is contained between every two layers of the (020) faces. The pseudo-boehmite absorbs ink sufficiently so as to cause the ink to be fixed, and makes it possible to improve the absorptivity of ink and prevent ink from being blurred with the passage of time. Sol-form pseudo-boehmite (pseudo-boehmite sol) may be used as raw material since the sol can easily give a smooth layer.

In the invention, the blend ratio between the inorganic particles A and the inorganic particles B, which are different in particle diameter, (specifically, the ratio of A/B) is from 25/75 to 75/25. When the blend ratio is in this range, the transmission density of black images is effectively improved while the total-light-ray transmittance is improved. The blend ratio (A/B) is more preferably from 25/75 to 50/50.

The total content of the inorganic particles in the ink receiving layer is preferably from 50 to 90% by mass, more preferably from 60 to 80% by mass, based on the total mass of the layer.

### <Water-Soluble Resin>

The ink receiving layer in the invention can be constituted, preferably using at least one of a water-soluble resin. Examples of the water-soluble resin include a polyvinyl alcohol (PVA), a polyvinyl acetal, a cellulose resins such as methylcellulose (MC), ethylcellulose (EC), hydroxyethylcellulose (HEC) and carboxymethylcellulose (CMC), chitins, chitosans, starch, resins having ether bonds such as polyethylene oxide (PEO), polypropylene oxide (PPO), polyethylene glycol (PEG) and polyvinyl ether (PVE), resins having amide groups or amide bonds such as polyacrylamide (PAAM) and polyvinylpyrrolidone (PVP), and resins having carboxyl groups as dissociating groups such as polyacrylic acid salts, maleic acid resin, alginic acid salts and gelatin.

These may be used alone or in combination of two or more thereof.

Among them, polyvinyl alcohol (PVA) is preferable.

The polyvinyl alcohol (PVA) may be used together with one or more of the above-mentioned water-soluble resins other than PVA. In this case, the ratio of the mass of PVA in the mass of the total of the water-soluble resins is preferably 90% or more by mass, more preferably 95% or more by mass.

The polyvinyl alcohol (PVA) includes, as species thereof, cation-modified polyvinyl alcohol, anion-modified polyvinyl alcohol, silanol-modified polyvinyl alcohol and other polyvinyl alcohol derivatives besides polyvinyl alcohol. About polyvinyl alcohol, only one of them may be used, or two or more of them may be used together.

The polyvinyl alcohol (PVA) has, in each structural unit thereof, a hydroxyl group. However, this hydroxyl group is combined with one of silanol groups on the surfaces of the silica particles to form a hydrogen bonding, thereby making it easy to form a three-dimensional network structure having, as each chain unit thereof, a secondary particle of the silica particles. The structure of this three-dimensional network structure would make it possible to form an ink receiving layer having a porous structure high in void percentage. The ink receiving layer formed to have the porous structure rapidly absorbs ink on the basis of capillarity at the time of ink-jet recording. Consequently, dots that are completely round at a high level and give no ink-blurring can be formed.

As the polymerization degree of polyvinyl alcohol (PVA), the number-average polymerization degree is preferably 1800 or more, more preferably 2000 or more with a view point of preventing the crack of the ink receiving layer. The saponification degree of PVA is preferably 88% or more, more preferably 95% or more from the viewpoint of transparency and the viscosity of a coating solution for forming the ink receiving layer (hereinafter referred to as a “coating solution for the ink receiving layer” or an “ink receiving layer coating solution”).

The content of the water-soluble resin (PVA is particularly preferable) in the ink receiving layer is preferably 9 to 40% by mass, more preferably 12 to 33% by mass, based on the total mass of the solid matter in ink receiving layer.

When the content is in this range, the following can be prevented: a decline in the strength of the layer, and cracking thereof when the layer is dried, due to excessive reduction of the content, and a phenomenon whereby due to an excessive content the pores are easily blocked by the resin so that the porosity decreases, whereby the ink absorptivity lowers.

### =Content Ratio Between the Inorganic Particles and the Water-Soluble Resin=

The content ratio between the inorganic particles (i) and the water-soluble resin (p) [PB ratio (i/p): part(s) by mass of the inorganic particles to 1 part by mass of the water-soluble resin] produces an effect on the film structure of the layer formed. Specifically, as the PB ratio becomes larger, the porosity, the pore volume and the surface area (per unit mass) become larger. The PB ratio is preferably from 1.5/1 to 10/1. When the Pb ratio is in this range, the following can be prevented: a decline in the strength of the layer, and cracking thereof when the layer is dried, these defects being based on the matter that this PB ratio is too large; and a phenomenon that because of an excessively small PB ratio the pores are easily blocked by the resin so that the porosity decreases, whereby the ink absorptivity lowers.

When any ink jet recording media passes through a transporting system of an ink-jet printer, stress may be applied thereto. Accordingly, the ink receiving layer in the invention is required to have a sufficient film strength. The sufficient film strength is required also from the viewpoint of preventing the ink receiving layer from being cracked or peeled when the medium of the invention is cut into a sheet form. From this viewpoint, the PB ratio is preferably 5/1 or less. In order that the medium can keep high-speed ink absorptivity certainly for an ink-jet printer, the PB ratio is preferably 2/1 or more.

When a dispersion solution prepared by dispersing silica particles and a water-soluble resin completely into an aqueous solution to set the PB ratio into the range of 2/1 to 5/1 is applied onto a support and then dried, a three-dimensional network structure having, as each chain unit thereof, a secondary particle of the silica particles is formed. Thus, a transparent porous layer can easily be formed.

### <Other Components>

In the ink jet recording media of the invention, its ink receiving layer can contain therein various components, such as a water-soluble polyvalent metal compound, a cross-linking agent, a mordant and a surfactant besides the inorganic particles and the water-soluble resin.

### —Water-Soluble Polyvalent Metal Compound—

The water-soluble polyvalent metal compound, which is used to improve the dispersion stability of the inorganic particles when the particles are dispersed into a solution, includes a water-soluble salt of a metal selected from calcium, barium, manganese, copper, cobalt, nickel, aluminum, iron, zinc, zirconium, chromium, magnesium, tungsten, and molybdenum.

Specific examples thereof include calcium acetate, calcium chloride, calcium formate, calcium sulfate, calcium butyrate, barium acetate, barium sulfate, barium phosphate, barium oxalate, barium naphthoresorcincarboxylate, barium butyrate, manganese chloride, manganese acetate, manganese formate dihydrate, manganese ammonium sulfate hexahydrate, cupric chloride, copper (II) chloride ammonium dihydrate, copper sulfate, copper (II) butyrate, copper oxalate, copper phthalate, copper citrate, copper gluconate, copper naphthenate, cobalt chloride, cobalt thiocyanurate, cobalt sulfate, cobalt (II) acetate, cobalt naphthenate, nickel sulfate hexahydrate, nickel chloride hexahydrate, nickel acetate tetrahydrate, nickel ammonium sulfate hexahydrate, nickel amidesulfate tetrahydrate, nickel sulfaminate, nickel 2-ethylhexanoate, aluminum sulfate, aluminum sulfite, aluminum thiosulfate, aluminum polychloride, aluminum nitrate nonahydrate, aluminum chloride hexahydrate, aluminum acetate, aluminum lactate, basic aluminum thioglycolate, ferrous bromide, ferrous chloride, ferric chloride, ferrous sulfate, ferric sulfate, iron (III) citrate, iron (III) lactate trihydrate, iron (III) trioxalate triammonium trihydrate, zinc bromide, zinc chloride, zinc nitrate hexahydrate, zinc sulfate, zinc acetate, zinc lactate, zirconium acetate, zirconium chloride, zirconium oxychloride octahydrate, zirconium hydroxychloride, chromium acetate, chromium sulfate, magnesium acetate, magnesium oxalate, magnesium sulfate, magnesium chloride hexahydrate, magnesium citrate nonahydrate, sodium phosphorus tungstate, sodium tungsten citrate, 12 tungstophosphoric acid n-hydrate, 12 tungstosilicic acid 26-hydrate, molybdenum chloride, and 12 molybdophosphoric acid n-hydrate. These may be used alone or in combination of two or more thereof.

The word “water-soluble” in the water-soluble polyvalent metal compound means that the compound is dissolved in water of 20° C. temperature in an amount of 1% or more by mass.

Among the water-soluble polyvalent metal compounds, preferable are compounds containing aluminum or a metal element in the group 4A in the periodic table (the group 4 in the 18-group long periodic table) (e.g., zirconium or titanium). In particular preferable is a water-soluble aluminum compound. Preferable examples of the water-soluble aluminum compound include aluminum chloride or hydrates thereof, aluminum sulfate or hydrates thereof, and ammonium alum as inorganic salts; and basic poly(aluminum hydroxide) compounds, which are inorganic aluminum-containing cationic polymers.

The basic poly(aluminum hydroxide) compounds are compounds containing a main component represented by the following formula 1, 2 or 3:

[Al₂(OH)ₙCl₆₋ₙ]ₘ formula 1,

[Al(OH)₃]ₙAlCl₃ formula 2, or

Alₙ(OH)ₘCl₍₃ₙ₋ₘ₎[ wherein 0<m<3n] formula 3.

Examples thereof include water-soluble poly(aluminum hydroxide) compounds which each contain a basic, polymeric polynuclear condensed ion stably, such as [Al₆(OH)₁₅]³⁺, [Al₈(OH)₂₀]⁴⁺, [Al₁₃(OH)₃₄]⁵⁺, and [Al₂₁(OH)₆₀]³⁺.

Examples of commercially available products thereof include poly(aluminum chloride) (PAC), and water-treating agents (trade name: PAC #100 and Takibine #1500), which are each manufactured by Taki Chemical Co., Ltd.; a product manufactured by Grace Japan K.K. (trade name: Cylojet A200); and a product manufactured by Riken Green Co., Ltd. (trade name: HAP-25); and other commercially available products supplied for the same purpose. From these products, compounds having various grades can easily be obtained.

The above-mentioned compounds containing a metal element in the group 4A in the periodic table are more preferably water-soluble compounds containing titanium or zirconium. Examples of the water-soluble compounds containing titanium include titanium chloride, and titanium sulfate. Examples of the water-soluble compounds containing zirconium include zirconium acetate, zirconium chloride, zirconium oxychloride, zirconium hydroxychloride, zirconium nitrate, basic zirconium carbonate, zirconium hydroxide, zirconium lactate, zirconium ammonium carbonate, zirconium potassium carbonate, zirconium sulfate, and zirconium fluoride compounds.

The content by percentage of the water-soluble polyvalent metal compound in the ink receiving layer is preferably from 20 to 40% by mass, based on the above-mentioned inorganic particles. When the content is in this range, a dispersion solution wherein the zeta-potential ζ is in a dispersion-stable potential range of 60 mV or more is effectively prepared.

If the content is less than 20% by mass, the zeta-potential ζ of the dispersion solution declines so that particles of the compound are unstably dispersed, whereby the particles may easily be agglomerated. If the content is more than 40% by mass, the following adverse effects may be produced: a non-image area affected by exposure to light or heating is generated, and the area yellows resulting in low whiteness.

### —Cross-Linking Agent—

The cross-linking agent is an agent for crosslinking the above-mentioned water-soluble resin. The inclusion of the cross-linking agent makes it possible that a three-dimensionally network structure cured by crosslinking reaction between the cross-linking agent and the water-soluble resin is formed. Thus, a transparent porous layer can be formed.

The cross-linking agent for the above-mentioned water-soluble resin, in particular polyvinyl alcohol-based resin, is preferably a boron compound. Examples of the boron compound include borax, boric acid, borates (e.g., orthoborates, InBO₃, ScBO₃, YBO₃, LaBO₃, Mg₃(BO₃)₂, Co₃(BO₃)₂), diborates (e.g., Mg₂B₂O₅, and Co₂B₂O₅), metaborates (e.g., LiBO₂, Ca(BO₂)₂, NaBO₂, and KBO₂), tetraborates (e.g., Na₂B₄O₇.10H₂O), pentaborates (e.g., KB₅O₈.4H₂O, Ca₂B₆O₁₁.7H₂O, and CsB₅O₅). Among them, borax, boric acid, and borates are preferable, and boric acid is more preferable since they can cause crosslinking reaction rapidly.

Besides the boron compound, the following compounds can be also used: aldehyde-based compounds such as formaldehyde, glyoxal, and glutaraldehyde; ketone-based compounds such as diacetyl, and cyclopentanedione; active halogenated compounds such as bis(2-chloroethylurea)-2-hydroxy-4,6-dichloro-1,3,5-triazine, and a sodium salt of 2,4-dichloro-6-S-triazine; active vinyl compounds such as divinylsulfonic acid, 1,3-vinylsulfonyl-2-propanol, N,N′-ethylenebis(vinylsulfonylacetamide), and 1,3,5-triacryloyl-hexahydro-S-triazine; N-methylol compounds such as dimethylolurea, and methyloldimethylhydantoin; melamine resins such as methylolmelamine, and alkylated methylolmelamine; epoxy resin;

Isocyanate-based compounds such as 1,6-hexamethylenediisocyanate, aziridine-based compounds described in U.S. Pat. Nos. 3,017,280 and 2,983,611; carboxyimide-based compounds described in U.S. Pat. No. 3,100,704; epoxy-based compounds such as glycerol triglycidyl ether; ethyleneimino-based compounds such as 1,6-hexamethylene-N,N′-bisethyleneurea; halogenated carboxyaldehyde-based compounds such as mucochloric acid, and mucophenoxychloric acid; dioxane-based compounds such as 2,3-dihydroxydioxane; metal-containing compounds such as titanium lactate, aluminum sulfate, chromium alum, potassium alum, zirconium acetate, and chromium acetate; polyamine compounds such as tetraethylenepentamine; hydrazide compounds such as dihydrazide adipate; and low molecular weight compounds or polymers each containing two or more oxazoline groups. These cross-linking agents may be used alone or in combination of two or more thereof.

The cross-linking agent may be added to an ink receiving layer coating solution or a coating solution for forming a layer adjacent to the ink receiving layer when the ink receiving layer coating solution is applied. Alternatively, the cross-linking agent can be supplied to the ink receiving layer by applying an ink receiving layer coating solution onto a support on which a coating solution containing the cross-linking agent is beforehand applied or by applying an ink receiving layer coating solution which contains or does not contain the cross-linking agent, drying the solution and then applying a solution which contains the cross-linking agent thereon as an overcoat, or by some other method.

Preferably, the cross-linking agent can be supplied to the ink receiving layer as described in the following example, wherein a boron compound is used:

In the case that the ink receiving layer is a layer formed by crosslinking and curing an applied layer obtained by applying an ink receiving layer coating solution (first solution), the crosslinking and curing can be performed by supplying a basic solution containing the cross-linking agent (second solution) (1) at the same time when the first solution is applied, thereby forming an applied layer, or (2) in the middle of drying the applied layer formed by the applying of the first solution and before the applied layer exhibits falling rate drying. At this time, it is sufficient that the boron compound, which is the cross-linking agent, is contained in either one of the first and second solutions. The boron compound may be contained in both the solutions. When the ink receiving layer is composed of two or more layers, two or more coating solutions can be applied into a multi-layer form (multi-layer application or multi-coating). The second solution should be supplied onto the formed multi-layer.

The content by percentage of the cross-linking agent in the ink receiving layer (or the ink receiving layer coating solution) is preferably from 1 to 50% by mass, more preferably from 5 to 40% by mass, based on the above-mentioned water-soluble resin.

### —Surfactant—

A surfactant is preferably included into the ink receiving layer coating solution.

The surfactant may be any one of cationic, anionic, nonionic, amphoteric, fluorine-based and silicon-based surfactants. About the surfactant, only one of them may be used, or two or more of them may be used together.

Examples of the nonionic surfactants include polyoxyalkylene alkylethers and polyoxyalkylene alkylphenyl ethers (e.g., diethylene glycol monoethylether, diethylene glycol diethylether, polyoxyethylene laurylether, polyoxyethylene stearylether, polyoxyethylene nonylphenylether, and the like); oxyethylene-oxypropylene block copolymers; sorbitan aliphatic esters (e.g., sorbitan monolaurate, sorbitan monooleate, sorbitan trioleate, and the like); polyoxyethylene sorbitan aliphatic esters (e.g., polyoxyethylene sorbitan monolaurate, polyoxyethylene sorbitan monooleate, polyoxyethylene sorbitan trioleate, and the like); polyoxyethylene sorbitol aliphatic esters (e.g., polyoxyethylene sorbit tetraoleate and the like); glycerin aliphatic esters (e.g., glycerol monooleate and the like); polyoxyethylene glycerin aliphatic esters (e.g., polyoxyethylene glycerol monostearate, polyoxyethylene glycerol monooleate, and the like); polyoxyethylene aliphatic esters (e.g., polyethylene glycol monolaurate, polyethylene glycol monooleate, and the like); polyoxyethylene alkylamines; acetylene glycols (e.g., 2,4,7,9-tetramethyl-5-decyne-4,7-diol, ethylene oxide and propylene oxide adducts of the diol, and the like); and the like. Polyoxyalkylene alkylethers are preferable.

The amphoteric surfactants include amino acid-type, carboxy ammonium betaine-type, sulfone ammonium betaine-type, ammonium sulfate ester betaine-type, imidazolium betaine-type, and other surfactants. For example, the amphoteric surfactants described in U.S. Pat. No. 3,843,368, JP-A Nos. 59-49535, 63-236546, 5-303205, 8-262742, and 10-282619, and the like may be favorably used. Among them, amino acid-type amphoteric surfactants are preferable as the amphoteric surfactant. Examples of the amino acid-type amphoteric surfactants include those described in JP-A No. 5-303205, i.e., N-acylamino acids having a long chain acyl group and the salts thereof, which are induced from amino acids (glycine, glutamic acid, histidine, and the like).

Examples of the anionic surfactants include aliphatic acid salts (e.g., sodium stearate, potassium oleate), alkyl sulfate ester salts (e.g., sodium lauryl sulfate, triethanolamine lauryl sulfate), sulfonate salts (e.g., sodium dodecylbenzenesulfonate), alkyl sulfosuccinate salts (e.g., sodium dioctyl sulfosuccinate), alkyl diphenyletherdisulfonate salts, alkyl phosphate salts, and the like.

Examples of the cationic surfactants include alkylamine salts, quaternary ammonium salts, pyridinium salts, imidazolium salts, and the like.

The fluorine-based surfactants include compounds prepared via an intermediate having a perfluoroalkyl group by means of electrolytic fluorination, telomerization, oligomerization or the like. Example of these compounds include perfluoroalkyl sulfonate salts, perfluoroalkyl carboxylate salts, perfluoroalkyl ethylene oxide adducts, perfluoroalkyltrialkylammonium salt, perfluoroalkyl group-containing oligomers, perfluoroalkyl phosphate esters, and the like.

Silicone oils modified with organic groups are preferable as the silicon-based surfactant. The silicon-based surfactants may have a siloxane structural unit having the side-chain modified with an organic group, or one or both ends of the surfactant modified therewith. The organic group modification includes amino modification, polyether modification, epoxy modification, carboxyl modification, carbinol modification, alkyl modification, aralkyl modification, phenol modification, fluorine modification, and the like.

When the surfactant is included into the ink receiving layer coating solution, the content by percentage of the surfactant in the coating solution is preferably from 0.001 to 2.0% by mass, more preferably from 0.01 to 1.0% by mass.

### —Mordant—

In the invention, a mordant is preferably added to the ink receiving layer, for further improvement in the water resistance and resistance to bleeding over time of formed images. Both organic mordants such as cationic polymers (cationic mordants) and inorganic mordants such as water-soluble metal compounds may be used as the mordant. Among them, organic mordants are preferable, and cationic mordants are more preferable.

Presence of the mordant at least in the upper layer portion of ink receiving layer generates an interaction with a liquid ink having an anionic dye as the colorant, and thus stabilizes the colorant. The presence of mordant also allows further improvement in the water resistance and the resistance to bleeding over time of formed images.

In such a case, the mordant may be contained either in the ink receiving layer coating solution (first solution) or the basic solution (second solution) for forming the ink receiving layer, but is preferably contained in the second solution, which is different from the solution containing an inorganic particles (especially, vapor-phase-process silica). It is because addition of the mordant directly into the coating solution for the ink receiving layer (ink receiving layer coating solution) may result in coagulation in the presence of a vapor-phase-process silica having anion electric charges. However, adoption of the method of separately preparing and applying the mordant-containing solution and the coating solution for ink receiving layer eliminates the concern about coagulation of inorganic particles, and broaden the range of choice for the mordant.

As the cationic mordant, polymeric mordants having a primary to tertiary amino group or a quaternary ammonium salt group as the cationic functional group are favorably used. Nonpolymeric cationic mordants may also be used.

As the polymeric mordant, Homopolymers from monomers having a primary to tertiary amino group or a salt thereof or a quaternary ammonium salt group (hereinafter, referred to as the “mordant monomer”) and copolymers or condensation polymers of the mordant monomers with other monomers (hereinafter, referred to as the “nonmordant polymer”) are more preferably. These polymeric mordant may be used in the form of a water-soluble polymer or a latex particles dispersed in water.

Examples of the mordant monomers include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N.N-diethyl-N-benzyl-N-p-vinylbenzylammonium chloride, N,N-dimethyl-N-(4-methyl)benzyl-N-p-vinylbenzylammonium chloride, N,N-dimethyl-N-phenyl-N-p-vinylbenzylammonium chloride;

trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate;

quartemary ammonium compounds prepared by reactions of methyl chloride, ethyl chloride, methyl bromide, ethyl bromide, methyl iodide or ethyl iodide with N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminoethyl (meth)acrylamide, N,N-diethylaminoethyl (meth)acrylamide, N,N-dimethylaminopropyl (meth)acrylamide, or, N,N-diethylaminopropyl(meth)acrylamide; or the anion-exchanged sulfonates, alkylsulfonates, acetates or alkyl carboxylates thereof; and the like.

Specific compounds include, for example, monomethydiallylammonium chloride, trimethyl-2-(methacrlyloyloxy)ethylammonium chloride, triethyl-2-(methacrlyloyloxy)ethylammonium chloride, trimethyl-2-(acryloyloxy)ethylammonium chloride, triethyl-2-(acryloyloxy)ethylammonium chloride, trimethyl-3-(methacrlyloyloxy)propylammonium chloride, triethyl-3-(methacrlyloyloxy)propylammonium chloride, trimethyl-2-(methacylyloylamino)ethylammonium chloride, triethyl-2-(methacylyloylamino)ethylammonium chloride, trimethyl-2-(acryloylamino)ethylammonium chloride, triethyl-2-(acryloylamino)ethylammonium chloride, trimethyl-3-(methacylyloylamino)propylammonium chloride, triethyl-3-(methacylyloylamino)propylammonium chloride, trimethyl-3-(acryloylamino)propylammonium chloride, triethyl-3-(acryloylamino)propylammonium chloride;

N,N-dimethyl-N-ethyl-2-(methacrlyloyloxy)ethylammonium chloride, N,N-diethyl-N-methyl-2-(methacrlyloyloxy)ethylammonium chloride, N,N-dimethyl-N-ethyl-3-(acryloylamino)propylammonium chloride, trimethyl-2-(methacrlyloyloxy)ethylammonium bromide, trimethyl-3-(acryloylamino)propylammonium bromide, trimethyl-2-(methacrlyloyloxy)ethylammonium sulfonate, trimethyl-3-(acryloylamino)propylammonium acetate; and the like.

In addition, copolymerizable monomers such as N-vinylimidazole and N-vinyl-2-methylimidazole are also included.

Further, allylamine, diallyamine, the derivatives and salts thereof may also be used. Examples of these compounds include allylamine, allylamine hydrochloride, allylamine acetate, allylamine sulfate, diallyamine, diallyamine hydrochloride, diallyamine acetate, diallyamine sulfate, diallylmethylamine and the salts thereof (e.g., hydrochloride, acetate, and sulfate salts, and the like), diallylethylamine and the salts thereof (e.g., hydrochloride, acetate, and sulfate salts, and the like), diallyldimethylammonium salts (counter anions thereof including chloride, acetate, and sulfate ions), and the like. These allylamine and diallyamine derivatives are less polymerizable in the amine form, and thus are commonly polymerized in the salt form and desalted thereafter if necessary.

Polymers having a vinyl amine unit, which are prepared by polymerizing a polymerization unit such as N-vinyl acetamide, N-vinyl formamide, or the like and hydrolyzing the resulting polymer, and the salts thereof may also be used.

The nonmordant monomer described above is a monomer that does not contain a basic or cationic group such as a primary to tertiary amino group or a salt thereof, or a quaternary ammonium salt group, and thus does not interact or has a practically smaller interaction with the dye in ink-jet ink.

Examples of the nonmordant monomers include: (meth)acrylic acid alkyl esters: (meth)acrylic acid cycloalkyl esters such as cyclohexyl (meth)acrylate; (meth)acrylic acid aryl esters such as phenyl (meth)acrylate; aralkyl esters such as benzyl (meth)acrylate; aromatic vinyl compounds such as styrene, vinyltoluene, and α-methylstyrene; vinylesters such as vinyl acetate, vinyl propionate, and vinyl versatate; allyl esters such as allyl acetate; halogen-containing monomers such as vinylidene chloride and vinyl chloride; vinyl cyanides such as (meth)acrylonitrile; olefins such as ethylene and propylene; and the like.

(Meth)acrylic acid alkyl esters having an alkyl group having 1 to 18 carbons are preferable as the (meth)acrylic acid alkyl ester. Specific examples thereof include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethylhexyl (meth)acrylate, lauryl (meth)acrylate, stearyl (meth)acrylate, and the like. Among them, methyl acrylate, ethyl acrylate, methyl methacrylate, ethyl methacrylate, and hydroxyethyl methacrylate are preferable. The nonmordant monomers may also be used alone or in combination of two or more.

Other favorable examples of the cationic mordants include polydiallydimethylammonium chloride, polymethacrlyloyloxyethyl-β-hydroxyethyldimethylammonium chloride, polyethyleneimine, polyallylamine and the derivatives thereof, polyamide-polyamine resins, cationized starch, dicyandiamide formalin condensates, dimethyl-2-hydroxypropylammonium salt polymers, polyamidine, polyvinylamine, dicyan-based cationic resins as typified by dicyandiamide-formalin polycondensates, polyamine-based cationic resins as typified by dicyanamide-diethylenetriamine polycondensates, epichlorohydrin-dimethylamine addition polymers, dimethyldiallylammonium chloride-SO₂ copolymers, diallyamine salt-SO₂ copolymers, (meth)acrylate-containing polymers having a quaternary ammonium salt group-substituted alkyl group in the ester portion, styryl type polymers having a quaternary ammonium salt group-substituted alkyl group, and the like.

Specific examples of the cationic mordants include those described in JP-A Nos. 48-28325, 54-74430, 54-124726, 55-22766, 55-142339, 60-23850, 60-23851, 60-23852, 60-23853, 60-57836, 60-60643, 60-118834, 60-122940, 60-122941, 60-122942, 60-235134, and 1-161236; U.S. Pat. Nos. 2,484,430, 2,548,564, 3,148,061, 3,309,690, 4,115,124, 4,124,386, 4,193,800, 4,273,853, 4,282,305, and 4,450,224; JP-A Nos. 1-161236, 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777, and 2001-301314; JP-B Nos. 5-35162, 5-35163, 5-35164, and 5-88846; JP-A Nos. 7-118333 and 2000-344990; Japanese Patent Nos. 2648847 and 2661677; and the like. Among them, polyallylamine and the derivatives thereof are preferably and diallydialkylcation polymers are structurally preferable.

As the polyallylamine or the derivatives thereof, various allylamine polymers and the derivatives thereof known in the art may be used. Examples of these derivatives include salts of polyallylamine and an acid (the acids include inorganic acids such as hydrochloric acid, sulfuric acid, phosphoric acid, and nitric acid; organic acids such as methanesulfonic acid, toluenesulfonic acid, acetic acid, propionic acid, cinnamic acid, and (meth)acrylic acid, and the combinations thereof; and allylamine partially converted to the salt is also included), derivatives of polyallylamine prepared by polymer reactions, and copolymers of polyallylamine and a other copolymerizable monomer [the monomers include typically (meth)acrylic esters, styrenes, (meth)acrylamides, acrylonitrile, vinylesters, and the like].

Specific examples of the polyallylamine and the derivatives thereof include those described in JP-B Nos. 62-31722, 2-14364, 63-43402, 63-43403, 63-45721, 63-29881, 1-26362, 2-56365, 2-57084, 4-41686, 6-2780, 6-45649, 6-15592, and 4-68622; Japanese Patent Nos. 3199227 and 3008369; JP-A Nos. 10-330427, 11-21321, 2000-281728, 2001-106736, 62-256801, 7-173286, 7-213897, 9-235318, 9-302026, and 11-21321; WO 99/21901 and 99/19372; JP-A No. 5-140213; Japanese Patent Application National Publication (Laid-Open) No. 11-506488; and the like.

Among the cationic mordants, diallyldialkylcation polymers are preferable, and diallyldimethylcation polymers are particularly preferable. The cationic mordant is preferably a cationic polymer having a weight-average molecular weight of 60,000 or less, more preferably of 40,000 or less, from the viewpoints of dispersibility, especially of preventing increase in viscosity.

The cationic mordant is also useful as the dispersant for the particles.

When added into the coating solution for ink receiving layer, the sulfate ion concentration in the coating solution is preferably 1.5% or less by mass, from the viewpoint of preventing increase in viscosity. The sulfate ion is derived from the polymerization initiator or the like used during production of the cationic polymer. Accordingly, it is advantageous to use a cationic mordant prepared by using a polymerization initiator or the like that does not release sulfate ions, as the sulfate ions remain in the polymer, The inorganic mordants include polyvalent water-soluble metal salts and hydrophobic metal salt compounds. Specific examples thereof include salts or complexes of metals such as magnesium, aluminium, calcium, scandium, titanium, vanadium, manganese, iron, nickel, copper, zinc, gallium, germanium, strontium, yttrium, zirconium, molybdenum, indium, barium, lanthanum, cerium, praseodymium, neodymium, samarium, europium, gadolinium, dysprosium, erbium, ytterbium, hafnium, tungsten, and bismuth.

More specific examples thereof include calcium acetate, calcium chloride, calcium formate, calcium sulfate, barium acetate, barium sulfate, barium phosphate, manganese chloride, manganese acetate, manganese formate dihydrate, manganese ammonium sulfate hexahydrate, cupric chloride, cupric ammonium chloride dihydrate, copper sulfate, cobalt chloride, cobalt thiocyanate, cobalt sulfate, nickel sulfate hexahydrate, nickel chloride hexahydrate, nickel acetate tetrahydrate, nickel ammonium sulfate hexahydrate, nickel amidosulfate tetrahydrate, aluminium sulfate, aluminium alum, basic polyhydroxy aluminum, aluminum sulfite, aluminum thiosulfate, polychlorinated aluminum, aluminium nitrate nonahydrate, aluminium chloride hexahydrate, ferrous bromide, ferrous chloride, ferric chloride, ferrous sulfate, ferric sulfate, zinc phenolsulfonate, zinc bromide, zinc chloride, zinc nitrate hexahydrate, zinc sulfate, titanium tetrachloride, tetraisopropyl titanate, titanium acetylacetonate, titanium lactate, zirconium acetylacetonate, zirconyl acetate, zirconyl sulfate, zirconium ammonium carbonate, zirconyl stearate, zirconyl octoate, zirconyl nitrate, zirconium oxychloride, zirconium hydroxychloride, chromium acetate, chromium sulfate, magnesium sulfate, magnesium chloride hexahydrate, magnesium citrate nonahydrate, sodium phosphotungstate, sodium tungsten citrate, undecatungstophosphoric acid n-hydrate, undecatungstosilicic acid 26-hydrate, molybdenum chloride, undecamolybdophosphoric acid n-hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerium chloride, cerium sulfate, cerium octoate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate, and the like.

Among the inorganic mordants, aluminium-containing compounds, titanium-containing compounds, zirconium-containing compounds, and metal compounds (salts or complexes) of the metals in group IIIB of the periodic table are preferable.

The amount of the mordant added in the ink receiving layer is preferably 0.01 to 5 g/m² and more preferably 0.1 to 3 g/m².

### —Other Components—

The ink receiving layer (or a coating solution for ink receiving layer) in the invention may additionally contain, if necessary, various additives known in the art such as ultraviolet-absorbent, antioxidant, fluorescent whitening agent, monomer, polymerization initiator, polymerization inhibitor, anti-bleeding agent, antiseptic, viscosity stabilization agent, antifoamer, surfactant, antistatic agent, matting agent, anti-curl agent, water-resistance imparting agent, and the like. The other components may be used alone or in combination of two or more.

### <<Production of the Ink Jet Recording Media>>

The ink jet recording media of the invention can be favorably producted by a process comprising applying, over a transparent support having a total-light-ray transmittance of 80% or more, a coating solution comprising at least two kinds of inorganic particles A and inorganic particles B, the species having different from each other in particle diameter, and preferably comprising a water-soluble resin, (i.e., an ink receiving layer coating solution: a first solution), thereby forming an applied layer; adding a cross-linking agent to the coating solution and/or a basic solution described below; and giving the applied layer a basic solution having a pH of 7.1 or more (i.e., a second solution) (1) at the same time when the coating solution is applied, thereby forming the applied layer, or (2) in the middle of drying the applied layer formed by the applying of the coating solution and before the applied layer exhibits falling rate drying, thereby crosslinking and curing the applied layer (wet-on-wet process).

A mordant in the ink receiving layer is desirably caused to be present in such a manner that the thickness of the portion where the mordant is present from the surface of the ink receiving layer is from 10 to 60% of the thickness of the ink receiving layer. For example, this can be attained by a method (1) of forming an applied layer and then applying a mordant-containing solution onto the layer, a method (2) of applying the first layer and a mordant-containing solution into a multi-layer form, or some other method.

The ink receiving layer coating solution (first solution) can be prepared, for example, as follows:

Inorganic particles A and B, such as sedimentation process silica, are added together with a dispersing agent and others to water (for example, the amount of the silica particles in water is from 10 to 20% by mass). The particles and the others are pre-dispersed (primarily dispersed) with a homo-mixer or the like, and subsequently this dispersion solution is dispersed (secondarily dispersed) by use of a disperser such as an ultrasonic disperser. Thereafter, thereto is added an aqueous solution of polyvinyl alcohol (PVA) (in such a manner that the mass of PVA turns into, for example, about ⅓ by mass of the silica particles), thereby preparing the first solution. It is preferable to adjust the pH of the coating solution into about 9.2 with ammonia water or the like or use a dispersing agent in order to give stability to the coating solution. The resultant coating solution is in a homogeneous sol state. This is applied onto a support by a coating method described below, and then dried, whereby a porous ink receiving layer having a three-dimensional network structure can be formed.

The disperser used in the dispersing may be selected from various conventional dispersers such as a colloid mill disperser, a high-speed rotating disperser, medium-stirring type dispersers (such as a ball mill and a sand mill), an ultrasonic disperser, and a high-pressure disperser. The ultrasonic disperser or high-pressure disperser (e.g., a high-pressure jet-disperser) is particularly preferable since particles formed in an aggregate form can be effectively dispersed.

Water, an organic solvent, or a mixed solvent thereof may be used as the solvent in the respective processes. Examples of the organic solvents used in the coating include alcohols such as methanol, ethanol, n-propanol, i-propanol, and methoxypropanol; ketones such as acetone and methylethylketone; tetrahydrofuran; acetonitrile; ethyl acetate; toluene; and the like.

As the dispersing agent, a cationic polymer can be used. Examples of the cationic polymer are equivalent to the examples of the above-mentioned mordant. It is also preferable to use a silane coupling agent as the dispersing agent.

The added amount of the dispersing agent is preferably from 0.1 to 30% by mass, more preferably from 1 to 10% by mass, based on the amount of the particles.

The coating solution for ink receiving layer may be coated by any one of the methods known in the art, for example, by using an extrusion die coater, air doctor coater, blade coater, rod coater, knife coater, squeeze coater, reverse roll coater, bar coater, or the like.

The basic solution (second solution) is applied simultaneously with or after the application of coating solution for ink receiving layer (first solution). The second solution may be applied before the coated layer exhibits falling rate drying when dried. Namely, the ink receiving layer may be favorably formed by introducing the second solution during the coated layer exhibits constant rate of drying after application of the coating solution (first solution) for ink receiving layer. The second solution may contain a mordant.

Here, the phrase “before the coated layer exhibits falling rate drying when dried” indicates a period of several minutes after application of the coating solution for ink receiving layer, wherein the content of the solvent (dispersion medium) in the coated layer decreases over time in the manner of “constant rate of drying”. The period of this “constant rate of drying” is described in, for example, Chemical Engineering Handbook (pp. 707 to 712, published by Maruzen Co., Ltd., Oct. 25, 1980).

As described above, after application of the first solution, the coated layer is dried commonly at 40 to 180° C. for 0.5 to 10 minutes (preferably, 0.5 to 5 minutes) until the coated layer exhibits falling rate drying. The drying period of course varies according to the amount coated, but is commonly in the above range.

The method of applying the second solution before the coated layer constituted by the first solution exhibits falling rate drying is, for example, a method of (i) coating the second solution additionally onto the coated layer, (ii) spraying the second solution thereon, (iii) immersing the support on which the coated layer is formed in the second solution, or the like.

With respect to the method (i), the coating method of applying the second solution may be any one of coating methods known in the art such as those using a curtain flow coater, an extrusion die coater, an air doctor coater, a blade coater, a rod coater, a knife coater, a squeeze coater, a reverse roll coater, a bar coater, and the like. Among them, a coating method whereby the coater does not brought into direct contact with the coated layer, such as that using an extrusion die coater, a curtain flow coater, a bar coater or the like, may be preferably used.

The second solution is commonly dried and cured by heating at 40 to 180° C. for 0.5 to 30 minutes after application. Preferably, the solution is heated at 40 to 150° C. for 1 to 20 minutes.

Alternatively, if the basic solution (second solution) is preferably applied simultaneously with the coating solution for ink receiving layer (first solution), the first and second solutions may be simultaneously applied onto the support (multi-layer application) and then dried, to form an ink receiving layer.

The simultaneous application (multi-layer application) may be performed by the coating method using, for example, an extrusion die coater or curtain flow coater. The coated layers formed after the simultaneous application is then dried. The coated layers in such a case are commonly dried by heating at 40 to 150° C. for 0.5 to 10 minutes, preferably, at 40 to 100° C. for 0.5 to 5 minutes.

When the simultaneous application (multi-layer application) is performed, for example, by using an extrusion die coater, two kinds of liquids simultaneously extruded are laminated in the neighborhood of the outlet of the extrusion die coater, i.e., before the liquids are applied onto the support, and applied onto the support as it is. The two layers of coating solutions laminated before application tend to make a crosslinking reaction at the interface of the two solutions before they are applied onto the support, often causing increase in viscosity due to mixing of the two solutions at the neighborhood of the extrusion die coater and sometimes causing troubles in the application operation. Therefore, during the simultaneous application, it is preferable to add a barrier-layer solution (intermediumte-layer solution) between the first and second solutions (simultaneous three-layer application).

The barrier-layer solution is not particularly limited, and examples thereof include an aqueous solution containing a trace amount of water-soluble resins, water, and the like. The water-soluble resins are used considering the coating property of the solution, for example, for increasing the viscosity of the solution, and examples thereof are polymers including cellulosic resins (e.g., hydroxypropylmethylcellulose, methylcellulose, hydroxyethylmethylcellulose, and the like), polyvinylpyrrolidone, gelatin, and the like. The barrier-layer solution may contain a mordant.

After formed on the support, the ink receiving layer may be subjected to calendering by passing through roll nips under heat and pressure, for example, by using a super calendering or gloss calendering machine, or the like, for improvement in the surface smoothness, glossiness, transparency, and strength of the coated film. However, because the calendering sometimes causes decrease in void percentage (i.e., decrease in ink absorptive property), it is necessary to set a condition smaller in the decrease in void percentage before calendering.

The roll temperature during calendering is preferably 30 to 150° C. more preferably 40 to 100° C., and the linear pressure between rolls during calendering is preferably 50 to 400 kg/cm and more preferably 100 to 200 kg/cm.

The thickness of the ink receiving layer is preferably from 20 μm to less than 50 μm, more preferably from 25 μm to less than 40 μm. When the thickness is in this range, the absorbing capacity of ink is made high so that at the time of jetting ink an overflow of the ink is eliminated. Accordingly, image defects, such as blurring, can be effectively overcome.

The ink absorbing capacity of the ink receiving layer formed as described above is preferably 10 cc/m² or more, more preferably 15 cc/M² or more. When the ink absorbing capacity is in this range, the absorptivity (absorbing speed) of jetted ink is good. Thus, at the time of recording, an image defect based on an overflow of ink can be avoided so that a high-quality image can be effectively recorded.

In the ink jet recording media of the invention, the total-light-ray transmittance thereof is preferably 30% or more and less than 70% since a bright image can be displayed. The haze value of the medium is preferably 90% or more in the state that the ink receiving layer and one or more optional layers are formed on the transparent support in order to prevent the following: at the time of arranging a light source such as a fluorescent lamp toward the rear face of the medium, which is the reverse face to the image observing face thereof, so as to display an image, a light source pattern makes its appearance on the observing face so that image quality is damaged.

The total-light-ray transmittance and the haze value can each be adjusted by selecting the species or amount of constituting components of the ink receiving layer or the other layer(s) appropriately.

The haze value can be measured with a haze meter (trade name: HGM-2DP, manufactured by Suga Test Instruments Co., Ltd.). The total-light-ray transmittance can be measured as described above.

In addition, the diameter of the voids in the ink receiving layer is preferably from 0.005 to 0.030 μm as a median size, and more preferably from 0.01 to 0.025 μm. The void percentage and the void median size may be determined by using a mercury porosimeter (trade name: “Poresizer 9320-PC2”, manufactured by Shimadzu Corporation).

Dispersed polymer particles may be added to the constituting layer(s) of the ink jet recording media obtained by the invention (e.g., its ink receiving layer or back layer). The dispersed polymer particles are used to stabilize the dimension, prevent curing, prevent adhesion, prevent the film from being cracked, or attain some other film physical property. The dispersed polymer particles are described in JP-A Nos. 62-245258, 62-1316648, and 62-110066. When the dispersed polymer particles having a low glass transition temperature (of 40° C. or lower) are added to the layer containing the mordant, the layer can be prevented from being cracked or curled. When the dispersed polymer particles having a high glass transition temperature are added to the back layer, the layer can be prevented from being curled as well.

### EXAMPLES

Hereinbelow, the invention will be described in detail by way of Examples. However, the invention is not limited to these Examples as long as the scope of the invention is not impaired. Unless otherwise specified, the “part” means ” parts by mass”.

### —Preparation of an Ink Receiving Layer Coating Solution A—

Out of components described below, (1) sedimentation process silica particles, (2) ion exchange water, (3) a dispersing agent (trade name: SHAROLL DC-902P), and (4) zirconyl acetate (trade name: ZA-30) were mixed, and the solid components were dispersed with an ultrasonic disperser (manufactured by Kabushiki Kaisha SMT). Thereafter, the resultant dispersion solution was heated to 45° C. and kept at the temperature for 20 hours. Thereafter, thereto were added (5) boric acid, (6) a solution wherein polyvinyl alcohol was dissolved, (7) an agent (trade name: SUPERFLEX 650), and (8) ethanol at 30° C., so as to prepare an ink receiving layer coating solution A.

### <Composition of the Ink Receiving Layer Coating Solution A>

(1) Sedimentation process silica particles [inorganic particles] (hereinafter referred to as “silica particle”): 10.0 parts

a mixture wherein silica particles having a particle diameter of 7.7 μm (trade name: P-78A, manufactured by Mizusawa Industrial Chemicals, Ltd.) and silica particles having a particle diameter of 0.64 μm (trade name: P-604, manufactured by Mizusawa Industrial Chemicals, Ltd.) were mixed at a ratio by mass of 75/25

(2) Ion exchange water: 62.8 parts

(3) Dispersing agent (51.5% solution in water): 0.87 part

trade name: “SHAROLL DC-902P”, manufactured by Dai-ichi Kogyo Seiyaku Co., Ltd.

(4) Zirconyl acetate: 0.54 part

trade name: ZA-30, manufactured by Daiichi Kigenso Kagaku Kogyo Co., Ltd.

(5) Boric acid [cross-linking agent]: 0.44 part

(6) Solution wherein polyvinyl alcohol [water-soluble resin] was dissolved: 34.9 parts

### —Composition—

PVA: 2.43 parts

trade name: PVA-235, manufactured by Kuraray Co., Ltd. (saponification degree: 88%, and polymerization degree: 3500)

Polyoxyethylene lauryl ether [surfactant] (10% solution in water): 0.08 part

trade name: EMULGEN 109P, manufactured by Kao Corporation (HLB value: 13.6)

Diethylene glycol monobutyl ether: 0.74 part

trade name: Butycenol 20P, manufactured by Kyowa Hakko Kogyo Co., Ltd.

Ion exchange water: 31.0 parts

(7) Agent (25% dispersion solution in water): 2.47 parts

trade name: SUPERFLEX 650, manufactured by Dai-ichi Kogyo Seiyaku Co., Ltd.

(8) Ethanol: 1.3 parts

### —Preparation of Ink Receiving Layer Coating Solutions B to Q—

Ink receiving layer coating solutions B to Q were prepared in the same way as in the preparation of the ink receiving layer coating solution A except that the silica particles were changed as shown in Table 1.

TABLE 1

| | Silica particles | | | | |
|---|---|---|---|---|---|
| | Silica 1 | | Silica 2 | | |
| Coating | P78A (75%) | 7.7 μm | P604 (25%) | 0.64 μm | Example 1 |
| solution A | | | | | |
| Coating | P78A (65%) | | P604 (35%) | | Example 2 |
| solution B | | | | | |
| Coating | P78A (50%) | | P604 (50%) | | Example 3 |
| solution C | | | | | |
| Coating | P78A (25%) | | P604 (75%) | | Example 4 |
| solution D | | | | | |
| Coating | P78A | 7.7 μm | | | Comparative |
| solution E | | | | | Example 1 |
| Coating | P604 | 0.64 μm | | | Comparative |
| solution F | | | | | Example 2 |
| Coating | P707 | 5.8 μm | | | Comparative |
| solution G | | | | | Example 3 |
| Coating | X-41 | 3.9 μm | | | Comparative |
| solution H | | | | | Example 4 |
| Coating | QS-05 | 0.15 μm | | | Comparative |
| solution I | | | | | Example 5 |
| Coating | QS-09 | 0.14 μm | | | Comparative |
| solution J | | | | | Example 6 |
| Coating | QS-10 | 0.13 μm | | | Comparative |
| solution K | | | | | Example 7 |
| Coating | QS-102 | 0.13 μm | | | Comparative |
| solution L | | | | | Example 8 |
| Coating | P78D | 13.1 μm | | | Comparative |
| solution M | | | | | Example 9 |
| Coating | X-60 | 11.7 μm | | | Comparative |
| solution N | | | | | Example 10 |
| Coating | Silysia 350 | 4.7 μm | | | Comparative |
| solution O | | | | | Example 11 |
| Coating | Nipseal | 0.49 μm | | | Comparative |
| solution P | E-220A | | | | Example 12 |
| Coating | P78A (85%) | 7.7 μm | P604 (15%) | 0.64 μm | Comparative |
| solution Q | | | | | Example 13 |

Details of the silica particles shown by their trade names in Table 1 are as follows:

P707: manufactured by Mizusawa Industrial Chemicals, Ltd.

X-41: manufactured by Tokuyama Corp.

QS-05: manufactured by Tokuyama Corp.

QS-09: manufactured by Tokuyama Corp.

QS-10: manufactured by Tokuyama Corp.

QS-102: manufactured by Tokuyama Corp.

78D: manufactured by Mizusawa Industrial Chemicals, Ltd.

X-60: manufactured by Tokuyama Corp.

Silysia 350: manufactured by Fuji-Silysia Chemical, Ltd.

Nipseal E-220A: manufactured by Tosoh Silica Corp.

### Example 1

### —Production of an Ink-Jet Recording Sheet—

A biaxially-oriented polyethylene terephthalate film (thickness: 175 μm) having a surface on which gelatin was painted as an undercoat was prepared. The ink receiving layer coating solution A was applied onto the undercoat face to give an application amount of 204 mL/m². At this time, aqueous solution of 8% by mass poly aluminum chloride (trade name: ALFINE 83, manufactured by Taimei Chemicals Co., Ltd.) was beforehand added into the ink receiving layer coating solution A immediately before the application of the solution A, so as to give an application amount of 12.0 mL/m².

After the application, the layer was dried at 80° C. (wind speed: 3 to 8 m/second) with a hot wind drier until the solid concentration in the applied layer turned into 20%. During this period, the applied layer exhibited constant rate of drying. This applied layrer was immersed into a basic solution C having a composition described below for 3 seconds before the layer exhibited falling rate drying, so that the solution was adhered onto the applied layer at an amount of 13 g/m². Thereafter, the resultant was further dried at 80° C. for 10 minutes.

As described above, an ink-jet recording sheet on which an ink receiving layer having a dry layer thickness of 33 μm was formed was produced.

### <Composition of the Basic Solution C>

(1) Boric acid: 0.65 part

(2) Zirconyl ammonium carbonate (28% solution in water): 2.5 parts trade name: ZIRCOZOL AC-7, manufactured by Daiichi Kigenso Kagaku Kogyo Co., Ltd.

(3) Ammonium carbonate (first grade; manufactured by Kanto Chemical Co., Inc.): 3.5 parts

(4) Ion exchange water: 63.3 parts

(5) Polyoxyethylene lauryl ether [surfactant] (2% solution in water): 30.0 parts

trade name: EMULGEN 109P, manufactured by Kao Corp. (HLB value: 13.6)

### Examples 2 to 4 and Comparative Examples 1 to 13

Ink-jet recording sheets were each produced in the same way as in Example 1 except that the ink receiving layer coating solution A was changed to each of ink receiving layer coating solutions B to Q shown in Table 1.

### (Measurement and Evaluation)

Each of the ink-jet recording sheets produced in the above-mentioned Examples and Comparative Examples was subjected to measurements and evaluations described in the following items 1 to 8. The results of the measurements and evaluations are shown in Table 2 described below.

### —1. Measurement of Ink Absorbing Capacity—

Each of the ink-jet recording sheets was cut into a test piece 10 cm square. Diethylene glycol of one milliliter was added dropwise onto this test piece, and then an excessive amount thereof was wiped off. The ink absorbing capacity (mL/m²) was obtained from the difference between the weights thereof before and after the addition.

### —2. Measurement of Total-Light-Ray Transmittance and Haze Value—

A haze measuring device (trade name: HGM-2DP, manufactured by Suga Test Instruments Co., Ltd.) was used to measure the total-light-ray transmittance (%) and the haze value (%) of each of the ink-jet recording sheets. The total-light-ray transmittance is desirably 30% or more. As the value is higher, a better display image is obtained.

### —3. Measurement of Ink Receiving Layer Thickness—

Each of the ink-jet recording sheets was cut with a microtome (trade name: LEICARM 2165, manufactured by Finetec Co., Ltd.), and the cut face was observed with an optical microscope. From the cut face, the thickness (μm) of the ink receiving layer was measured.

### —4. Measurement of Contact Angle—

Onto the ink receiving layer of each of the ink-jet recording sheet was added dropwise 2 μL of a cyan ink (manufactured by Seiko Epson Corp.) for an ink-jet printer (trade name: G800, manufactured by the same). After 300 milliseconds from the addition, the contact angle thereof was measured with a contact angle measuring device (trade name: Drop Master 700, manufactured by Kyowa Interface Science Co., Ltd.).

### —5. Evaluation of Density—

An ink-jet printer (trade name: G800, manufactured by Seiko Epson Corp.) was used to record a solid image by each of yellow, magenta, cyan and black onto each of the ink-jet recording sheets in a high-resolution mode (paper-setting: photographic paper). Thereafter, the sheet was stored at a temperature of 23° C. and a relative humidity of 60% for 24 hours. After the storage, the density of the solid image in each of the colors was measured with a transmission density measuring device (trade name: X-rite 310, manufactured by X-rite Co.), thereby evaluating the density. The black density is desirably 5.0 or more from the viewpoint of practical use.

### —6. Evaluation of Ink Overflow—

An ink-jet printer (trade name: G800, manufactured by Seiko Epson Corp.) was used to record a gray-scale image onto each of the ink-jet recording sheets in a high-resolution mode (paper-setting: photographic paper). Immediately after the recording, the gradation area was observed with the naked eye, and evaluated in accordance with the following evaluation criterion:

### <Evaluation Criterion>

A: No ink overflow was observed.

B: An ink overflow was slightly observed.

C: An ink overflow was remarkably observed.

### —7. Evaluation of Brightness Irregularity—

A white fluorescent lamp having a power of 15 W was arranged toward the ink receiving layer non-formed face (back face) of each of the ink-jet recording sheets which were each cut into an A4 size and each had no recorded image, so as to be positioned 2 cm apart from the sheet face. The degree of a fluorescent lamp pattern which was reflected on the ink receiving layer formed face (image observing face) so as to make its appearance thereon was observed with the naked eye, and evaluated in accordance with the following criterion:

### <Evaluation Criterion>

A: No fluorescent lamp pattern was reflected.

B: A fluorescent lamp pattern was slightly reflected but the reflected pattern was allowable from the viewpoint of practical use.

C: The degree of the reflection of the fluorescent lamp pattern was remarkable.

### —8. Evaluation of Yellowness—

The degree of yellowness of light emitted from the white fluorescent lamp and transmitted through each of the ink-jet recording sheets was evaluated in accordance with a criterion described below. Dependently on the kind of the used silica particles, the transmitted light from the white fluorescent lamp arranged at the backside may yellow.

### <Evaluation Criterion>

A: The transmitted light was white transmitted light, which did not yellow.

B: The transmitted light yellowed slightly, but the yellowness was allowable from the viewpoint of practical use.

C: The yellowness of the transmitted light was intense so that a dark and dull color image was given.

TABLE 2

| | | Absorbing | | Haze | Layer | Contact | | | | | Ink | Bright- | |
|---|---|---|---|---|---|---|---|---|---|---|---|---|---|
| | Silica | Capacity | Tt | value | thickness | angle | Yellow | Magenta | Cyan | Black | over- | Ness | |
| | particles | [ml/m²] | [%] | [%] | [μm] | [°] | density | density | density | density | flow | Irregularity | Yellowness |
| Example 1 | P78A/ | 16 | 46 | 94 | 30 | 12 | 1.2 | 1.5 | 0.8 | 5.3 | A | A | A |
| | P604 | | | | | | | | | | | | |
| Example 2 | P78A/ | 17 | 43 | 94 | 29 | 11 | 1.3 | 1.5 | 0.8 | 5.4 | A | A | A |
| | P604 | | | | | | | | | | | | |
| Example 3 | P78A/ | 17 | 36 | 94 | 32 | 10 | 1.4 | 1.7 | 0.9 | 6.0 | A | A | A |
| | P604 | | | | | | | | | | | | |
| Example 4 | P78A/ | 14 | 32 | 94 | 28 | 11 | 1.5 | 1.8 | 0.9 | 6.0 | B | A | A |
| | P604 | | | | | | | | | | | | |
| Comparative | P78A | 23 | 52 | 94 | 35 | 12 | 1.0 | 1.4 | 0.7 | 4.3 | A | A | A |
| Example 1 | | | | | | | | | | | | | |
| Comparative | P604 | 16 | 27 | 94 | 34 | 10 | 1.8 | 2.0 | 1.0 | 6.1 | B | A | A |
| Example 2 | | | | | | | | | | | | | |
| Comparative | P707 | 23 | 52 | 94 | 34 | 15 | 1.2 | 1.5 | 0.8 | 4.6 | A | A | A |
| Example 3 | | | | | | | | | | | | | |
| Comparative | X-41 | 20 | 67 | 92 | 30 | 14 | 1.1 | 1.2 | 0.6 | 4.8 | A | A | A |
| Example 4 | | | | | | | | | | | | | |
| Comparative | QS-05 | 16 | 39 | 94 | 26 | 18 | 1.5 | 1.7 | 0.8 | 5.6 | C | A | C |
| Example 5 | | | | | | | | | | | | | |
| Comparative | QS-09 | 17 | 52 | 84 | 27 | 18 | 1.4 | 1.7 | 0.7 | 5.5 | B | B | C |
| Example 6 | | | | | | | | | | | | | |
| Comparative | QS-10 | 18 | 62 | 75 | 29 | 23 | 1.1 | 1.3 | 0.5 | 4.7 | B | C | B |
| Example 7 | | | | | | | | | | | | | |
| Comparative | QS-102 | 16 | 83 | 31 | 26 | 22 | 0.8 | 0.8 | 0.3 | 3.7 | C | C | B |
| Example 8 | | | | | | | | | | | | | |
| Comparative | P78D | 21 | 63 | 94 | 32 | 7 | 0.8 | 0.9 | 0.6 | 2.8 | A | A | A |
| Example 9 | | | | | | | | | | | | | |
| Comparative | X-60 | 19 | 70 | 94 | 33 | 11 | 0.9 | 1.0 | 0.6 | 2.6 | A | A | A |
| Example 10 | | | | | | | | | | | | | |
| Comparative | Silysia | 23 | 64 | 94 | 39 | 14 | 1.0 | 1.3 | 0.6 | 3.6 | A | A | A |
| Example 11 | 350 | | | | | | | | | | | | |
| Comparative | Nipseal | 20 | 45 | 93 | 34 | 18 | 1.5 | 2.0 | 0.8 | 6.3 | A | B | A |
| Example 12 | E-220A | | | | | | | | | | | | |
| Comparative | P78A/ | 20 | 48 | 94 | 32 | 12 | 1.1 | 1.4 | 0.8 | 4.8 | A | A | A |
| Example 13 | P604 | | | | | | | | | | | | |

Tt [%]: total-light-ray transmittance

As shown in Table 2, the ink-jet recording sheets of the Examples each had a haze value of more than 90% and a total-light-ray transmittance of 30% or more; thus, the sheets were able to cause light from the fluorescent light lamp present at the backside to diffuse evenly. For this reason, the ink-jet recording sheets of the Examples exhibited images wherein no brightness irregularity was generated and the density of black was high.

On the other hand, the ink-jet recording sheets of Comparative Examples 1, 3, 4, 11 and 13 gave no brightness irregularity but were insufficient in color densities such as black density. The ink-jet recording sheet of Comparative Example 2 gave a high density but had a total-light-ray transmittance of less than 30%. Thus, the image therein was dark. Furthermore, the ink-jet recording sheet of Comparative Example 2 was poor in visibility of the displayed image. In the ink-jet recording sheets of Comparative Examples 5 and 6, a sufficient density was kept, but an ink overflow was generated since the layer thickness and the absorbing capacity were smaller than those of the ink-jet recording sheet of Example 1. Additionally, in the ink-jet recording sheets of Comparative Examples 5 and 6, their images were disturbed and the transmitted light was yellowish. In the ink-jet recording sheets of Comparative Examples 7 and 8, the total-light-ray transmittance was high but the degree of the brightness irregularity was poor. Thus, a pattern of the fluorescent lamp present at the backside was seen through. Moreover, in the ink-jet recording sheets of Comparative Examples 7 and 8, the ink absorbing capacity was also insufficient, so that an ink overflow was generated. In the ink-jet recording sheets of Comparative Examples 9 and 10, the particle diameter of silica was so large that the surface of the ink receiving layer was sandy. Moreover, even if a large amount of ink was jetted onto the ink-jet recording sheets of Comparative Examples 9 and 10, light went through the sheets without being affected by the dyes therein so that the density of black lowered remarkably.

According to the invention, it is possible to provide an ink jet recording media with which an ink overflow is suppressed at the time of recording, and the color hue of black is favorable so that images having a high black density can be recorded.

The present invention includes the following embodiment.

<1> An ink-jet recording media comprising:

a transparent support having a total-light-ray transmittance of 80% or more; and

an ink receiving layer which is arranged over the transparent support and comprises inorganic particles A wherein the average of agglomerated particle diameters is from 0.5 μm to less than 1 μm, and inorganic particles B wherein the average of agglomerated particle diameters is from 7.5 μm to less than 10 μm, the blend ratio of the inorganic particles A to the inorganic particles B (A/B) being from 25/75 to 75/25.

<2> The ink-jet recording media as described in <1>, wherein the ink absorbing capacity of the ink receiving layer is 10 cc/m² or more.

<3> The ink-jet recording media as described in <1> or <2>, wherein the total-light-ray transmittance of the transparent support and all layers arranged over the transparent support, including the ink receiving layer, is from 30% to less than 70%.

<4> The ink-jet recording media as described in any one of <1> to <3>, having a haze value of 90% or more.

<5> The ink-jet recording media as described in any one of <1> to <4>, wherein the thickness of the ink receiving layer is from 20 μm to less than 50 μm.

<6> The ink-jet recording media as described in any one of <1> to <5>, wherein the inorganic particles are sedimentation process silica.

<7> The ink-jet recording media as described in any one of <1> to <6>, wherein the average of the agglomerated particle diameters of the inorganic particles A is from 0.5 μm to less than 0.8 μm, and the average of the agglomerated particle diameters of the inorganic particles B is from 7.5 μm to less than 9 μm.

<8> The ink-jet recording media as described in <6>, wherein the ratio of the sedimentation process silica in all of the inorganic particles is 50% or more by mass.

<9> The ink-jet recording media as described in any one of <1> to <8>, wherein the blend ratio (A/B) is from 25/75 to 50/50.

<10> The ink-jet recording media as described in any one of <1> to <9>, wherein the ink receiving layer further comprises a water-soluble resin and at least one of the water-soluble resin is polyvinyl alcohol.

<11> A method of producing an ink-jet recording media, comprising applying, over a transparent support having a total-light-ray transmittance of 80% or more, a coating solution comprising inorganic particles A wherein the average of agglomerated particle diameters is from 0.5 μm to less than 1 μm and inorganic particles B wherein the average of agglomerated particle diameters is from 7.5 μm to less than 10 μm, the blend ratio of the inorganic particles A to the inorganic particles B (A/B) being from 25/75 to 75/25, thereby forming an applied layer; and giving the applied layer a basic solution having a pH of 7.1 or more (1) at the same time when the coating solution is applied, thereby forming the applied layer, or (2) in the middle of drying the applied layer formed by the applying of the coating solution and before the applied layer exhibits falling rate drying, thereby crosslinking and curing the applied layer.

<12> A method of producing an ink-jet recording media as described in <11>, wherein the inorganic particles are sedimentation process silica.

<13> A method of producing an ink-jet recording media as described in <11> or <12>, wherein the average of the agglomerated particle diameters of the inorganic particles A is from 0.5 μm to less than 1 μm, and the average of the agglomerated particle diameters of the inorganic particles B is from 7.5 μm to less than 10 μm.

<14> A method of producing an ink-jet recording media as described in any one of <11> to <13>, wherein the blend ratio (A/B) is from 25/75 to 50/50.

<15> A method of producing an ink-jet recording media as described in any one of <11> to <14>, wherein the coating solution further comprises a water-soluble resin and a cross-linking agent for cross-linking the water-soluble resin.

<16> A method of producing an ink-jet recording media as described in <15>, wherein at least one of the water-soluble resin is polyvinyl alcohol.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An ink-jet recording media comprising:
a transparent support having a total-light-ray transmittance of 80% or more; and
an ink receiving layer which is arranged over the transparent support and comprises inorganic particles A wherein the average of agglomerated particle diameters is from 0.5 μm to less than 1 μm, and inorganic particles B wherein the average of agglomerated particle diameters is from 7.5 μm to less than 10 μm, the blend ratio of the inorganic particles A to the inorganic particles B (A/B) being from 25/75 to 75/25.

2. The ink-jet recording media according to claim 1, wherein the ink absorbing capacity of the ink receiving layer is 10 cc/m² or more.

3. The ink-jet recording media according to claim 1, wherein the total-light-ray transmittance of the transparent support and all layers arranged over the transparent support, including the ink receiving layer, is from 30% to less than 70%.

4. The ink-jet recording media according to claim 1, having a haze value of 90% or more.

5. The ink-jet recording media according to claim 1, wherein the thickness of the ink receiving layer is from 20 μm to less than 50 μm.

6. The ink-jet recording media according to claim 1, wherein the inorganic particles are sedimentation process silica.

7. The ink-jet recording media according to claim 1, wherein the average of the agglomerated particle diameters of the inorganic particles A is from 0.5 μm to less than 0.8 μm, and the average of the agglomerated particle diameters of the inorganic particles B is from 7.5 μm to less than 9 μm.

8. The ink-jet recording media according to claim 6, wherein the ratio of the sedimentation process silica in all of the inorganic particles is 50% or more by mass.

9. The ink-jet recording media according to claim 1, wherein the blend ratio (A/B) is from 25/75 to 50/50.

10. The ink-jet recording media according to claim 1, wherein the ink receiving layer further comprises a water-soluble resin and at least one of the water-soluble resin is polyvinyl alcohol.

11. A method of producing an ink-jet recording media, comprising applying, over a transparent support having a total-light-ray transmittance of 80% or more, a coating solution comprising inorganic particles A wherein the average of agglomerated particle diameters is from 0.5 μm to less than 1 μm and inorganic particles B wherein the average of agglomerated particle diameters is from 7.5 μm to less than 10 μm, the blend ratio of the inorganic particles A to the inorganic particles B (A/B) being from 25/75 to 75/25, thereby forming an applied layer; and giving the applied layer a basic solution having a pH of 7.1 or more (1) at the same time when the coating solution is applied, thereby forming the applied layer, or (2) in the middle of drying the applied layer formed by the applying of the coating solution and before the applied layer exhibits falling rate drying, thereby crosslinking and curing the applied layer.

12. A method of producing an ink-jet recording media according to claim 11, wherein the inorganic particles are sedimentation process silica.

13. A method of producing an ink-jet recording media according to claim 11, wherein the average of the agglomerated particle diameters of the inorganic particles A is from 0.5 μm to less than 1 μm, and the average of the agglomerated particle diameters of the inorganic particles B is from 7.5 μm to less than 10 μm.

14. A method of producing an ink-jet recording media according to claim 11, wherein the blend ratio (A/B) is from 25/75 to 50/50.

15. A method of producing an ink-jet recording media according to claim 11, wherein the coating solution further comprises a water-soluble resin and a cross-linking agent for cross-linking the water-soluble resin.

16. A method of producing an ink-jet recording media according to claim 15, wherein at least one of the water-soluble resin is polyvinyl alcohol.
